(19) United States
(12) Patent Application Publication
(10) Pub. No.: US 2006/0285177 A1
(43) Pub. Date: Dec. 21, 2006

(54) Return light adverse effect suppressing optical unit, image forming apparatus, and printing system

(76) Inventors: Minoru Morikawa, Kawasaki-shi (JP); Shinichi Suzuki, Yokosuka-shi (JP); Kazumi Ishima, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/455,826

(22) Filed: Jun. 20, 2006

(30) Foreign Application Priority Data
Jun. 21, 2005 (JP) 2005-180396

(51) Int. Cl. H04N 1/04

(52) U.S. Cl. 358/475

(57) ABSTRACT

An optical light source unit includes a light source that emits a beam, and a collimate lens that collimates the beam and executes imaging on an imaging surface. The beam substantially has light intensity of Gauss distribution in a cross section after passing through the collimate lens. A radius of the beam in a cross section is larger in a sub scanning direction than that in a main scanning direction at a beam waist and on the imaging surface. An entry angle of the beam entering the imaging surface with a normal line of the imaging surface is larger than a diverse angle of the beam returning and diverging from the imaging surface.

### CROSS REFERENCE TO RELATED APPLICATION

This application claims priority under 35 USC § 119 to Japanese Patent Application No. 2005-180396 filed on Jun. 21, 2005, the entire contents of which are herein incorporated by reference.

### BACKGROUND OF THE INVENTION

1. Field of the Invention

The present invention relates to a light source unit including a plurality of laser light sources arranged substantially at the same interval, an image forming apparatus mounting the laser light sources, and a printing system mounting the image forming apparatus. In particular, the present invention relates to such a light source unit or the like employed in an image setter or a plotter, which produces various machine plates, such as a CTP (Computer To Plate), a layout paper use film, a mask film, a print substrate, etc. The present invention also relates to an image forming apparatus that uses a silver salt film as a recordation medium, a direct imaging (DI) machine, and a printer or a copier that employs either one of monochrome and multicolor electro-photographic systems or a thermal printing system.

2. Discussion of the Background Art

A conventional image forming apparatus and light source unit are illustrated in FIGS. 12A and 12B, wherein FIG. 12A is a top view and FIG. 12B is a side view of the image forming apparatus when viewed in a sub scanning direction. As shown there, 100 denotes a light source unit that mounts plural pairs of light sources and collimate lens. 101 denotes a light source (e.g. a laser light source). 102 denotes a collimate lens. 103 denotes a beam that is emitted from a light source. 104 denotes a recordation medium of an image forming apparatus.

Further, a beam 103 emitted from the light source 101 directly reaches a recordation medium 104 via the collimate lens 102.

FIG. 12C illustrates a positional relation between the light source, the collimate lens, and an imaging surface. In order to obtain a prescribed beam radius ω₀(μm) on the imaging surface 105, a valid diameter D_{L} of the lens should be calculated by the following first formula, wherein L₂ represents a distance between a junction formed by an optical axis 106 and the collimate lens surface 102 and the imaging surface 105, L₁ (mm) represents a distance between the imaging surface 105 and the light source 101, and θ(=λ/(π×ω₀) radian) represents a diverse angle of the beam 103, in which λ represents a wavelength (micrometer) and π is a circle ratio in FIG. 12C:
2L₂ tan θ≦D_{L} (1)
Specifically, if the first formula is not established, the beam can't be narrowed to have a prescribed diameter.

Since the beam 103 from the light source 101 and narrowed by the collimate lens 102 becomes smaller on the imaging surface 105 in proportion to a diameter of the beam entering the collimate lens 102, such a diameter is determined in accordance with that of the beam emitted to the imaging surface 105. The optical axis 106 corresponds to a normal line of the imaging surface (i.e., a straight line extending from a light emission center of the light source 101 to a rotational center of a drum).

Accordingly, a distance indicated by “L₁-L₂” between the light source 101 and the collimate lens 102 is almost uniquely determined by both a diameter of a light that enters the collimate lens 102 from the light source 101 and an emission angle θ_{L} of a light inherent to each of the light sources.

The apparatus forms an image in a manner as mentioned below. When a drum carrying a recordation medium rotates once in a main scanning direction (i.e., a drum rotational direction), numbers of lines are formed on the recordation medium corresponding to those of the light sources emitting lights. When the drum completes the one rotation, the light source moves in a sub scanning direction (i.e., a light source unit moving direction) by an amount of one dot and the second line is formed by each of the light sources. When images formed by all of the light sources are connected to images formed by the adjacent light sources, image formation is completed. Alternatively, a light source unit is moved all the time in the sub scanning direction in synchronism with the drum rotation to form an image in a spiral state. When images formed by the respective light sources are connected to images formed by the adjacent light sources, the image formation is completed. The above-mentioned image forming method is generally called a drum scanning system.

In such a conventional image forming apparatus, a light emitted to a recordation medium surface is reflected by either the recordation medium surface or a drum surface, and such a reflected light enters the light source again, thereby causing the light source to be unstable with a vibration, for example.

Especially, when forming an image on a printing plate of a heat sensitive type as one of applications of a light source unit, impact of a returning light can't be neglected even if a light path is short, such as a few to 100 mm, because a high power output beam of from several dozens to 1000 mJ is emitted per square centimeter.

When forming an image using a laser beam having a Gauss distribution, a photosensitive surface of a recordation medium is generally positioned to almost coincide with a beam waist thereof. FIG. 13A represents a beam having such a Gauss distribution, and FIG. 13B is an enlarged view thereof.

As shown in FIGS. 13A and 13B, the Gauss distribution beam advances while expanding at a divergence angle θ (i.e., λ/(π×ω₀)) with the optical axis. The diversion angle θ=λ/(π×ω₀) is determined by the wavelength λ of a light emitted from the light source and a beam radius ω₀ at the beam waist. ω₀ represents a beam radius in a cross section at the beam waist position, and has 1/e² of the maximum optical power in the Gauss distribution as shown in FIG. 13C. Such ω₀ becomes ω1 or ω2 when the beam is only angled in the main or sub scanning directions as shown in FIG. 3.

Further, as shown in FIG. 13A, a change in a beam diameter is smallest at around the beam waist position. Thus, as mentioned above, if the photosensitive surface of the recordation medium almost coincides with the beam waist position, respective changes in a beam diameter and an energy distribution in the beam are suppressed to the minimum, even though an imaging surface moves toward a focal point.

Especially, in an image forming process using heat (e.g. a process in which a desired image is formed for plate making use by perforating a plate with heat of a laser light), a desired image can't be formed unless it is formed in the vicinity of a beam waist having high energy density.

However, a returning light from the imaging surface with high energy density also advances while expanding at an angle θ with an optical axis, and enters the light source again, thereby causing unstable operation of the light source.

Then, various attempts has been made to avoid impact of such a returning light from a drum as discussed in Japanese Patent Application Laid Open No. 2003-080663. Specifically, it is proposed that an optical axis of a laser light preferably inclines by two to three degree with a straight line extending from a light emission center of a laser diode to a rotational center of a plate drum. However, it is still insufficient.

### SUMMARY

The present invention has been made in view of the above noted and another problems and one object of the present invention is to provide a new and noble optical light source unit that includes a light source for emitting a beam, and a collimate lens for collimating the beam while executing imaging on an imaging surface of a medium. The beam substantially has light intensity of Gauss distribution in a cross section after passing through the collimate lens. A radius ω₂ of the beam in a cross section is larger in a sub scanning direction than that ω₁ in a main scanning direction at a beam waist. A radius ω4 of the beam is larger in a sub scanning direction than that ω3 in a main scanning direction on the imaging surface. The radius ω₃ is defined by the following formula when θₘₐᵢₙ is an angle of the beam entering the imaging surface in the main scanning direction with a normal line of the imaging surface;
ω₃=ω₁/cos θₘₐᵢₙ.

Further, an angle θₘₐₓ of the beam entering the imaging surface with the normal line of the imaging surface is larger than a diverse angle θ₀ of the beam returning and diverging from the imaging surface, wherein the diverse angle θ₀ is defined by the following formula, wherein λ is a wave length of the light source, π is a circular ratio, and ω₀ is a radius of the beam in a cross section at the beam waist in a beam entry direction;
θ₀=λ/(π×ω₀).

In another embodiment, the θₘₐₓ is the same to θₘₐᵢₙ, and ω₀ is the same to ω₁, when the entry beam is only angled in the main scanning direction

In yet another embodiment, a light deviation device is provided to change a direction and guides the beam to the imaging surface through the collimate lens.

In yet another embodiment, the light deviation device includes one of a mirror and a prism.

In yet another embodiment, an optical light source unit includes a first light source train having more than two light sources for emitting light beams from above an imaging position, and a second light source train having more than two light sources for emitting light beams from beneath the imaging position. The more than two light sources of the fist and second light source trains are staggered at a prescribed interval D₁ so that a light beam emitted from one of the more than two light sources of the first light source train does not enter the one of the more than two light sources of the second light source train after returning from the imaging surface.

In yet another embodiment, when the light source emits the light beam toward the imaging surface in the main scanning direction while a divergent angle θ₀ of the return light beam is defined by the following formula, the prescribed interval D₁ is calculated by the following formula, wherein λ is a wave length of the light source, π is a circular ratio, ω₂ is a radius of the light beam at a beam waist in the sub scanning direction, and L₁ is a distance from the light source to the imaging surface;
θ₀=λ/(π×ω₂);
D₁≧L₁×tan θ₀.

In yet another embodiment, an optical light source unit includes a first light source train having more than two pair of light sources and focal lenses for emitting light beams from above an imaging position, and a second light source train having more than two pair of light sources and focal lenses for emitting light beams from beneath the imaging position. These two focal lens of the first and second light source trains are mutually staggered at a prescribed interval so that a light beam emitted through one of the more than two light sources of the first light source train and returning from the imaging surface does not enter one of the more than two focal lens of the second light source train.

In yet another embodiment, when the beam enters the imaging surface in the main scanning direction through one of the plurality of focal lens while a divergent angle θ₂ of the return light is defined by the following formula, the prescribed interval D₂ is calculated by the following formula, wherein λ is a wave length of a light source, π is a circular ratio, ω₂ is a radius of the beam in the sub scanning direction at a beam waist, and L₂ is a distance between the focal lens and the imaging surface;
θ₂=λ/(π×ω₂);
D₂≧L₂ tan θ₂.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIGS. 1A and 1B collectively illustrates an exemplary configuration of an optical unit according to the first embodiment of the present invention;

FIGS. 2A and 2B collectively illustrates an exemplary beam entering an object at an angle of θₘₐᵢₙ with a main scanning direction;

FIG. 3 illustrates an exemplary beam shape appearing at a beam waist position;

FIG. 4 illustrates an exemplary configuration of a light source unit according to the present invention;

FIGS. 5A and 5B collectively illustrates an exemplary configuration of an optical unit according to a second embodiment of the present invention;

FIGS. 6A to 6C collectively illustrates an exemplary configuration of an optical unit according to a third example of the present invention;

FIGS. 7A and 7B collectively illustrates an exemplary arrangement of light sources and lenses for avoiding returning lights;

FIGS. 8A to 8F collectively illustrates an exemplary modification modifying the third embodiment according to the present invention;

FIGS. 9A and 9B collectively illustrates an exemplary light source unit according to the third embodiment;

FIGS. 10A to 10C collectively illustrates an exemplary image forming apparatus that mounts the light source unit according to the present invention;

FIG. 11A illustrates an exemplary printing system that mounts the image forming apparatus according to the present invention;

FIG. 11B illustrates an exemplary printing system that mounts the image forming apparatus according to the present invention;

FIG. 11C illustrates an exemplary printing system that mounts the image forming apparatus according to the third embodiment;

FIGS. 12A to 12C collectively illustrates a conventional image forming apparatus and a conventional light source unit; and

FIGS. 13A to 13C collectively illustrates an exemplary beam having a Gauss distribution.

### PREFERRED EMBODIMENTS OF THE PRESENT INVENTION

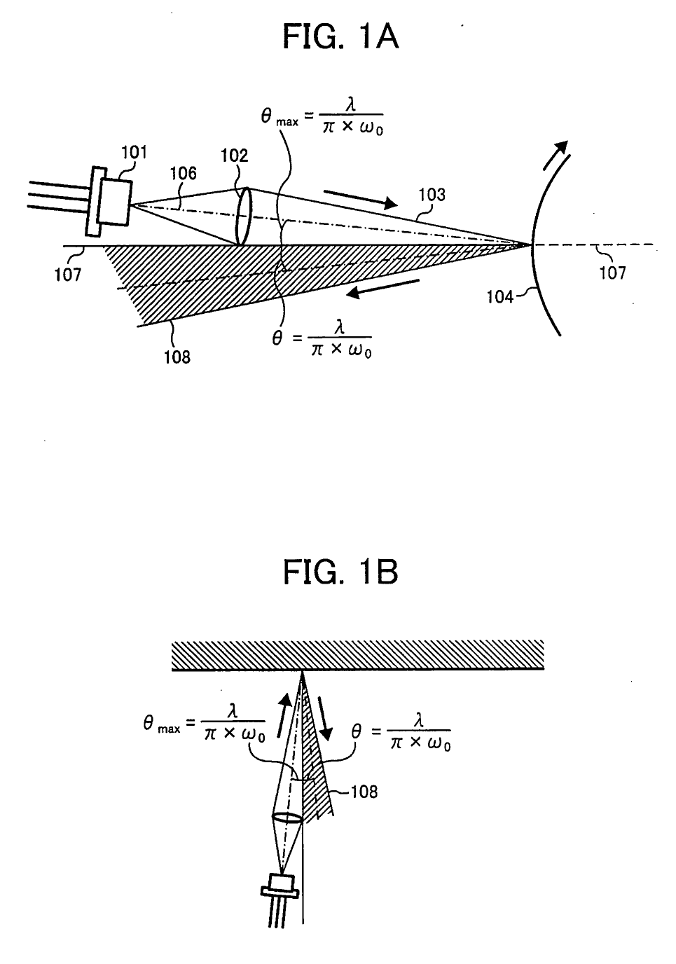

Referring now to the drawings, wherein like reference numerals and marks designate identical or corresponding parts throughout several figures, in particular in FIG. 1, the first embodiment is initially described.

As shown, 101 denotes a light source (e.g. a laser), 102 denotes a collimate lens, 103 denotes a beam irradiated from the light source, 104 denotes a recording medium of an image forming apparatus, 106 denotes an optical axis, and 107 denotes a normal line of an imaging surface.

These devices are substantially the same to those of the background art. 108 denotes a returning light (i.e., a reflection light) from the imaging surface.

FIG. 1A is a side view of an optical unit inclining in a main scanning direction at an angle θₘₐₓ with the normal line at an imaging position.

As shown, the optical unit laterally irradiates a beam. FIG. 1B is a top view of an optical unit inclining in the sub scanning direction at an angle θₘₐₓ with the normal line. As shown, the optical unit irradiates a beam from beneath (e.g.).

When an angle of a beam entering the imaging surface is smaller than the above-mentioned diversion angle θ, the retuning light 108 enters the light source 101. Then, to avoid impact of the return light to the light source 101, the maximum angle θₘₐₓ is set to be more than θ (=λ/(π×ω₀)) to meet the following relation as shown in FIGS. 1A and 1B;
θₘₐₓ≧θ.

The above-mentioned angle θₘₐₓ with the normal line of the imaging surface is the largest, and can be set in every direction beside the main and sub scanning directions. An angle of a beam entering an imaging surface enabling to avoid impact of a return light varies depending on a wavelength and a beam radius at an imaging surface.

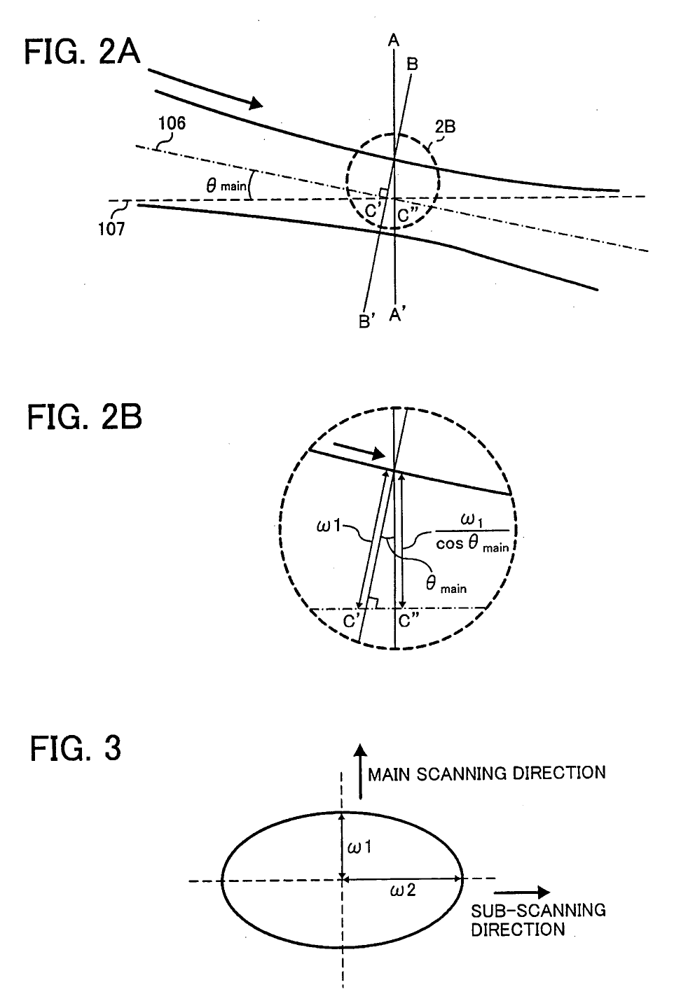

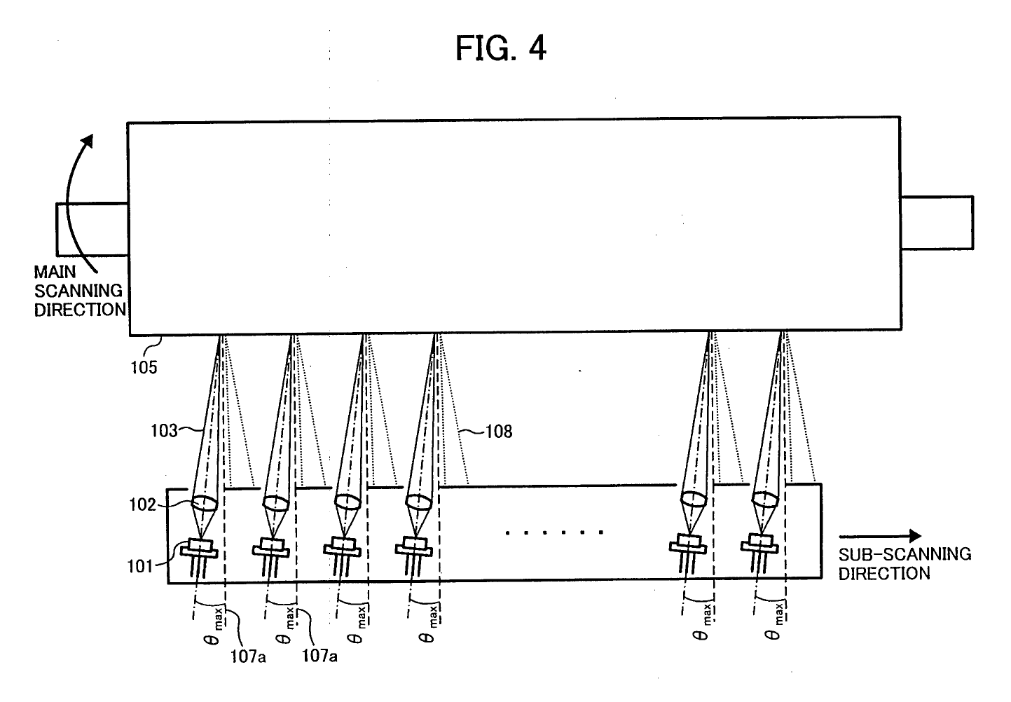

As mentioned above, impact of the return light can be removed when θₘₐₓ (radian) is large enough. However, abeam shape changes at an imaging surface as a result. Then, an entry angle θₘₐᵢₙ with a normal line 107 at an imaging surface is restricted in a main scanning direction by the reason as described below with reference to FIGS. 2 and 3.

FIGS. 2A and 2B collectively illustrates an exemplary beam having an entry angle of θₘₐᵢₙ only in a main scanning direction, wherein FIG. 2B is an enlarged view of FIG. 2A. A-A′ of FIG. 2A represents a position of an imaging surface. B-B′ represents a plane perpendicular to an optical axis 106 at a beam waist position. C-C′ of FIG. 2B represents a beam radius at the beam waist position. C-C″ represents a beam radius on the imaging surface A-A′.

FIG. 3 illustrates an exemplary beam shape formed at a beam waist position. When the beam radius in the main scanning direction is ω₁ (μm) and that in the sub scanning direction is ω₂ (μm), the beam radius C-C″ in the main scanning direction on the imaging surface A-A′ is calculated as follows:
ω₁/cos θₘₐᵢₙ (3)
Accordingly, when an entry angle θₘₐᵢₙ is set larger, the beam radius C-C″ in the main scanning direction becomes large on the imaging surface A-A′.

It was found in the above-mentioned drum scanning type image forming apparatus that when the beam radius ω₂ is not larger than that of ω₁ in the main scanning direction on the imaging surface, image quality deteriorates. Also found was that image quality significantly deteriorates when the beam radius ω₁ exceeds that of ω₂.

Accordingly, these beam radius ω₂ and ω₁ are needed to meet the following relation:
ω₁/cos θₘₐᵢₙ≦ω₂ (4)

Especially, when a moving speed of the medium in the main scanning direction is slow, a dot image is similarly formed on the medium to a beam shape. However, when the medium moves at high speed, the beam radius in the main scanning direction needs to be suppressed not to become large, because a dot expands in the main scanning direction during beam irradiation. Specifically, to improve image quality while maintaining a stable output of an injection light from a light source, the above-mentioned second and fourth formulas should be met.

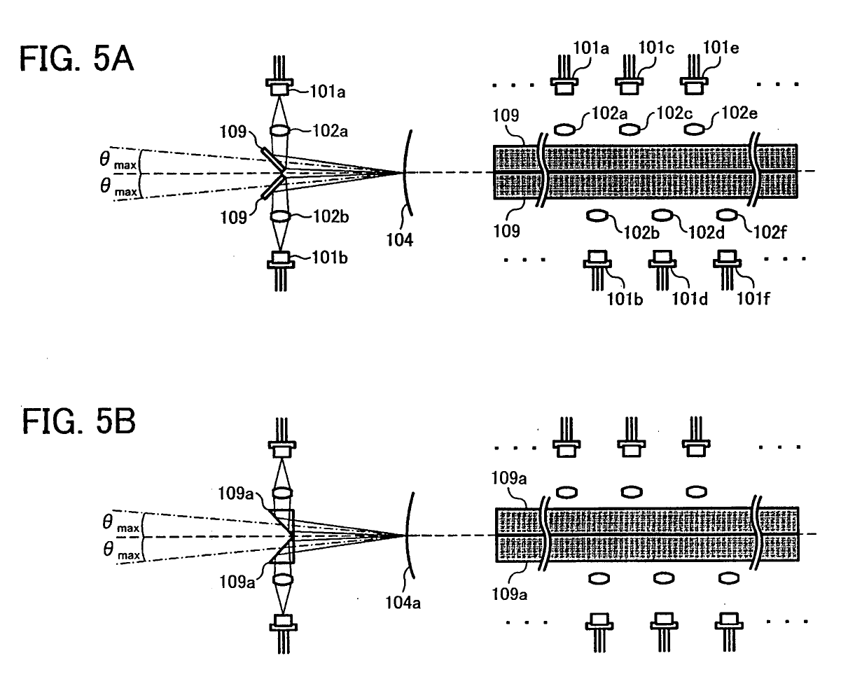

FIG. 4 illustrates another exemplary configuration of a light source unit according to one embodiment of the present invention. As shown, an angle of a beam entering an imaging surface 105 from each of the light sources inclines at an angle θₘₐₓ with a line 107 a perpendicular to a rotational axis of an medium holding device in the sub scanning direction (i.e., a left side). Thus, a returning light 108 from the light source 101 does not enter the own light source 101.

The beam entry angle θₘₐₓ can be on the right side of the line in the sub scanning direction in contrast to that in FIG. 4, or is on the upper side thereof in the main scanning direction as shown in FIG. 1A. Otherwise, the beam entry angle θₘₐₓ can be downward in the main scanning direction. Specifically, “a beam entry angle θₘₐₓ” made with a normal line extending from an imaging point to a medium holding device as calculated by the above-mentioned second formula can be formed in every directions.

When the beam entry angle θₘₐₓ only inclines in the main scanning direction with the normal line of the imaging surface, both θₘₐₓ and θₘₐᵢₙ are the same.

When a beam entering an imaging surface from each of the light sources has a larger angle with a line perpendicular to a rotational axis of the medium holding device in the sub scanning direction and a smaller angle than the θₘₐₓ in the main scanning direction is small, a dot shape is preferably formed on a medium. Because, the beam radius does not become larger in the main scanning direction.

However, when an interval between the light sources is narrow, a return light needs to be suppressed, because the return light of the neighboring light source causes impact. Further, a focal depth disadvantageously becomes shallow in proportion to an angle of a beam entering an imaging surface in view of stability and credibility.

According to this embodiment, a head is provided and employs a semiconductor laser light source that generates a light having a diameter of 9 mm, and a wavelength of 830 nm, and outputs a CW (Continuous Wave) of 100 mW or 150 mW in addition to the configuration as described with reference to FIG. 1. Specifically, a head is prepared including a plurality of light sources staggered substantially at the same interval of 5.588 mm to be integral multiple of a pixel pitch. Further prepared is a head including a train of a plurality of light sources arranged at substantially the same interval of 11.176 mm to be integral multiple of a pixel pitch. Then, an image of 2400 dpi is formed on a thermal CTP (Computer To Plate) or a heat sensitive coloring film using a leucodye or a developer on a condition that the beam entry angle was about 5.5 degree in the main scanning direction with the normal line of the imaging surface. As a result, a high quality image was obtained.

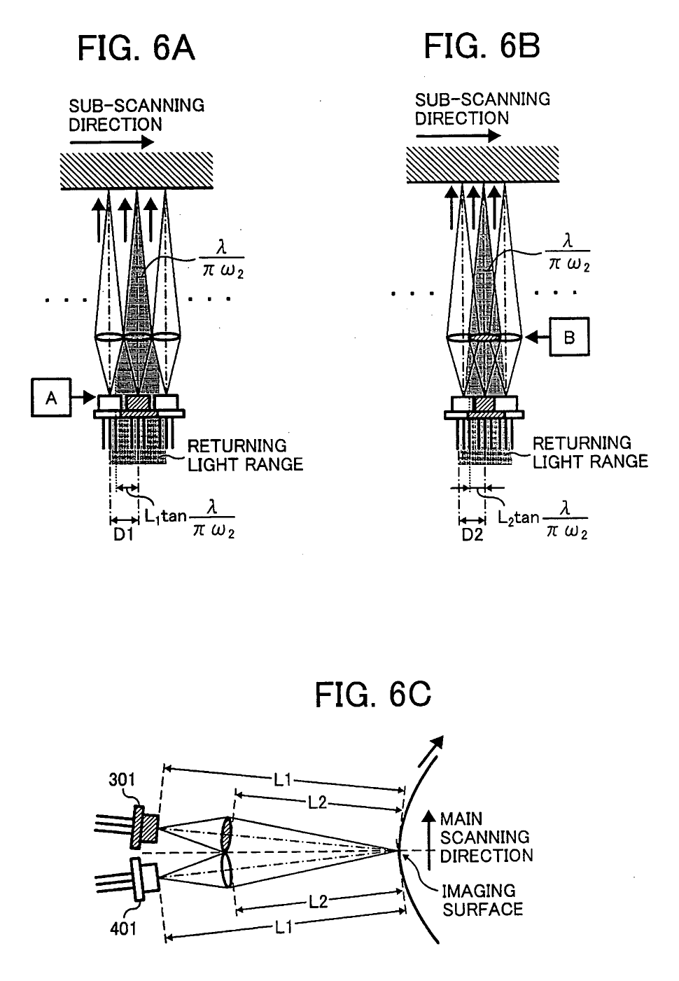

The second embodiment is now described with reference to FIGS. 5A and 5B, wherein FIG. 5A is a side view, while FIG. 5B is a plan view, and wherein a plurality of light sources are staggered. As shown, 101a to 101f denote light sources, 102a to 102f denote focal lenses, and 104 denotes a recordation medium as in the first embodiment. An optical deflection device 109 is arranged opposing the plurality of light sources 101a to 101f between the focal lenses 102a to 102f and the recordation medium 104. The deflection device 109 can be arranged per light source. The optical reflection device 109 has high reflection rate.

As shown, a plurality of beams emitted from the light sources 101a to 101f dispersed at substantially the same interval are reflected by the light reflection device 109 and enter an imaging surface. Specifically, the beams are guided to the imaging surface so that the entry angle θₘₐₓ of the beam reflected by the light reflection device 109 and entering the imaging surface meets the following fifth formula.
θₘₐₓ=λ/(π×ω₀) (5)

According to this embodiment, impact of the return light can be suppressed, and the entry angle θₘₐₓ toward the imaging surface can be minimized as far as possible.

The light reflection device is preferably made of material having a heat resistance and a performance of less variation per hour, such as a metallic mirror having metal coating, such as aluminum, etc., or glass. However, a plastic mirror can be most preferably employed in view of cost and environment. Further, a shape of the light reflection device can be plate like, L shape integrally mounting upper and lower light reflection members, or triangular.

FIG. 5B illustrates a modification of the second embodiment of FIG. 5A. Specifically, a prism is employed as a light deflection device 109a. Remaining constructional elements are the same as those described with reference to FIG. 5A. Specifically, a beam is similarly guided to the imaging surface so that the entry angle θₘₐₓ of the beam reflected by the light deflection device 109a and entering the imaging surface meets the above-mentioned fifth formula. Such a light deflection device 109a can be employed per either a plurality of the light sources or each of the light sources.

The above-mentioned prism can be every types as far as a direction of a laser beam is changed. However, material having a high light transmission rate, a heat resistance, and a performance of less variation per hour, such as glass, is preferable. However, a plastic prism can be most preferably employed in view of cost and environment or the like. Further, the prism can be a square having deflection planes at opposing corners. Upper and lower prisms can be integrated. Otherwise, various optical deflection members, such as an optical diffraction grating, a liquid crystal material capable of adjusting a deflection angle, etc., can be utilized.

Further, a light source emits a beam from above or beneath an imaging surface, while the beam is deflected by the light deflection device toward the imaging surface. However, the present invention is not limited thereto, and the beam can enter in various directions as far as the fifth formula is met. Further, a beam can be emitted to a light deflection device oppositely arranged to an imaging surface while meeting the fifth formula. Accordingly, an optical unit can be flexibly designed, especially when beams are staggered.

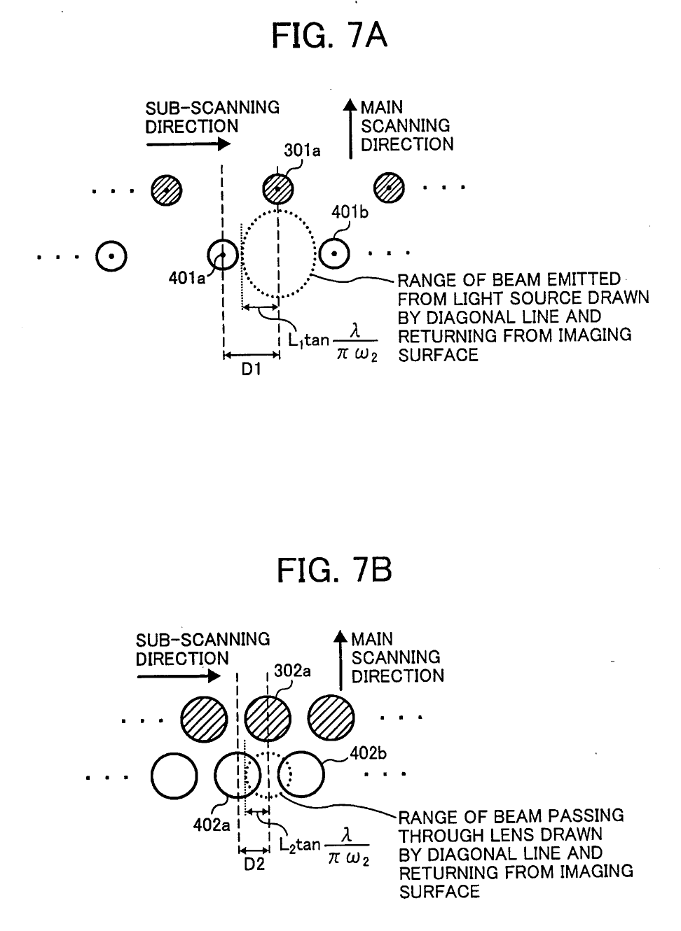

The third embodiment of a light source unit is now described with reference to FIGS. 6A, 6B, and 6C, wherein FIGS. 6A and 6B illustrate plan views, and FIG. 6C illustrates a side view thereof when viewed in the sub scanning direction.

An light source unit in this embodiment includes a light source train 301 including a plurality of light sources that emit lights from above an imaging surface, and that of 401 that emit light from beneath thereof. These light source units 301 and 401 are staggered. As shown in FIG. 6C, lights are emitted substantially perpendicular to the sub scanning direction from the above and beneath the imaging surface.

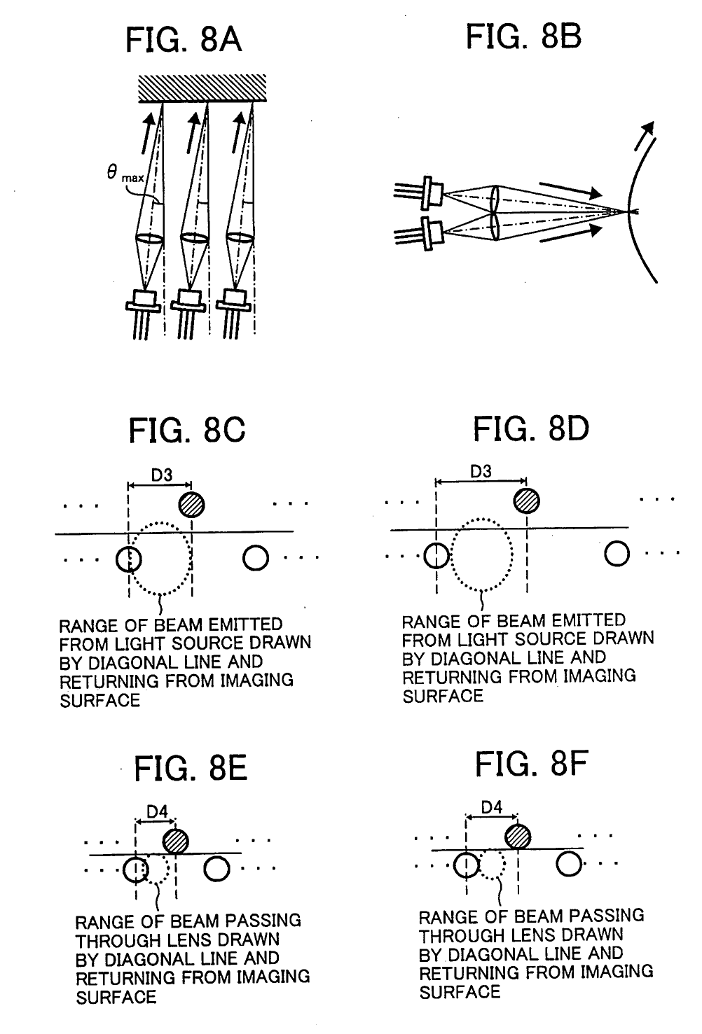

FIG. 7A illustrates the imaging surface viewed from the position A of FIG. 6A, and illustrates a positional relation between a light source and a return light. The position A is located on a plane including a plurality of beam projection outlets of light sources. As mentioned above, the light sources are staggered, and only the optical units 301 illustrated by slant lines are illustrated above. Further, a region shown by a shadow in FIGS. 6A and 6B represents a return light of a beam emitted from the upper light source 301 and passing below the upper light source 301.

Specifically, the light source unit having staggered light sources generates beams emitted from the above and beneath, so that each of the beams is reflected by an imaging surface and causes a return light. Accordingly, depending upon arrangement of the light sources, the return light emitted from the upper light source 301 likely invades the neighboring light source 401 arranged below. In contrast, the return light emitted from beneath the light source 401 likely invades the neighboring light source 301 arranged above. Then, the light source needs to be arranged at a prescribed position free from the impact of the return light.

A range affected by the return light can be determined by a divergent angle of the return light in the sub scanning direction and a distance between a light projection outlet and an imaging surface. The divergent angle θ₂ Of the return light in the sub scanning direction can be calculated from a beam radius ω₂ in the sub scanning direction at the beam waist and a wavelength λ of the light source using the following formula:
θ₂=λ/(π×ω₂).

Further, as shown in FIG. 6C, when a distance on the optical axis between each of the light projection outlets of the light sources 301 and 401 and the imaging surface is L1, a radius of the return light in the sub scanning direction at the position A is calculated by the following formula (See, FIGS. 6A and 7A):
L₁×tan (λ/(π×ω₂))

In FIG. 7A, when a distance between the light source 301a and the neighboring light source 401a arranged below in the sub scanning direction is D1, the distance D1 needs to be larger than the above-mentioned product “L₁×tan (λ/(π×ω₂))” so that a return light from the light source 301a does not enter the neighboring light source 401a. Here, a size of each of the light sources is neglected.

Thus, if these light sources are arranged while meeting the below described sixth formula, impact of the return light from the neighboring light source can be suppressed;
D₁≧L₁×tan (λ/(π×ω₂)). (6)

FIG. 7B is a positional relation between a light source and a return light when viewed from the position B of FIG. 6B toward the imaging surface. 302 denotes a lens positioned above. 402 denotes a lens positioned below. The position B is located on a plane including a position of a rear side nodal point of a lens. However, when an aspheric surface lens is used, the position B is located on a plane including an intersection of a lens surface on the imaging surface side and an optical axis.

A dotted line circle shows a return light of a beam that passes through the lens 302a and almost enters the lower side lens. Specifically, the return light likely enters the neighboring light source via the lens that leads the return light thereinto.

Then, the return light is controlled not to enter the lens. As mentioned earlier, a range affected by the return light can be determined by a divergent angle of the return light in the sub scanning direction and a distance between the rear side nodal point of the lens and the imaging surface or a distance between an intersection of a lens surface on the imaging surface side and an optical axis and the imaging surface when the aspheric surface lens is used.

The divergent angle θ₂ of the return light in the sub scanning direction can be calculated by the following formula as shown in FIG. 6B, wherein ω₂ is a beam radius in the sub scanning direction at the beam waist, and λ is a wavelength of the light source:
θ₂=λ/(π×ω₂).

When the aspheric surface lens is used while a distance between the rear side nodal point and the imaging surface, or that between the intersection of the lens plane on the imaging surface side and the optical axis and the imaging surface is L₂, a radius of the return light at the position B in the sub scanning direction is calculated by the following formula as shown in FIG. 6C:
L₂×tan (λ/(π×ω₂)).

When a distance between the lens 302a and the neighboring lens 402a in the sub scanning direction is D₂, the blow described formula should be established so that a return light does not enter the neighboring lens 402a as shown in FIG. 7B:
D₂≧L₂×tan (λ/(π×ω₂)). (7)

By arranging lenses while meeting the above-mentioned seventh formula, impact of the return light can be suppressed. In a practically used optical system, D₁ and D₂ are equalized so that the light source and lens coincide with the optical axis.

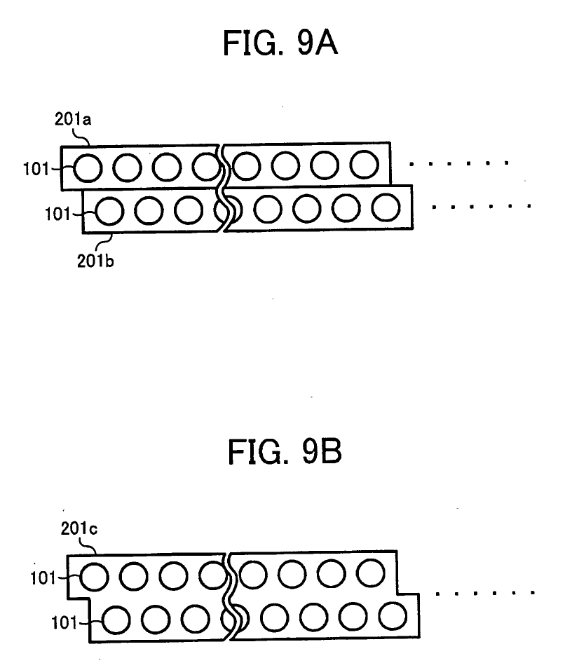

FIGS. 8A and 8B collectively illustrates a modification of the third embodiment, wherein an emission light beam inclines both main and sub-scanning directions of a medium at prescribed angles. Even when the six and the seventh formulas are met, impact of a return light of a beam emitted from the neighboring light source occurs as shown in FIGS. 8C and 8E. These intervals “d” of the light sources, and those of “f” of the lenses are more expanded so as to suppress such impact.

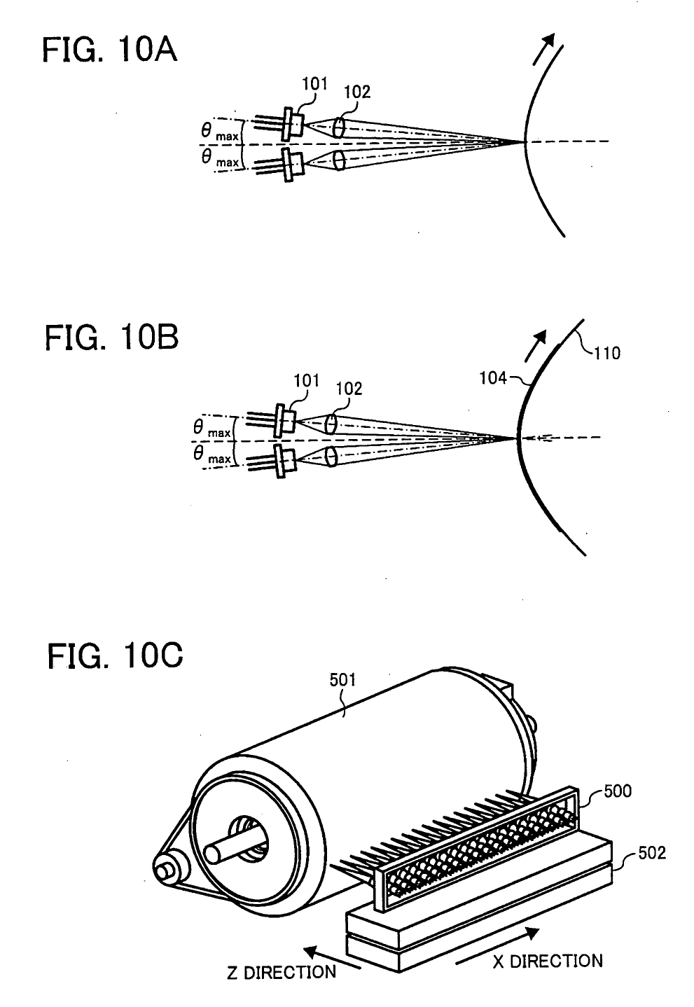

FIGS. 9A and 9B each illustrates an exemplary light source unit used in the third embodiment and its modification. Specifically,

FIG. 9A illustrates an exemplary optical unit including a plurality of units 201a and 201b each including a plurality of light sources 101 aligned on a dimension while those are staggered. Further, FIG. 9B illustrates an optical unit formed by a plurality of units 201c, in which light sources 101 are staggered.

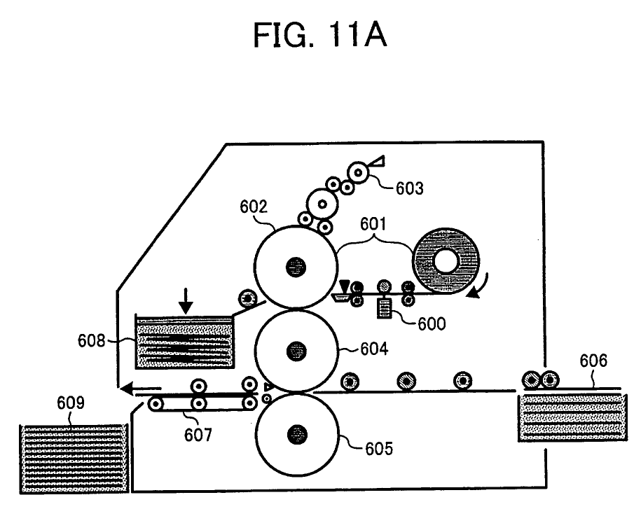

The fourth embodiment is now described with reference to FIGS. 10A to 10C, wherein the first to third examples of an image forming apparatus each mounts a light source unit including a light source and a focal lens. Specifically, FIG. 10A illustrates an example in which a drum surface forms a medium 104. FIG. 10B illustrates an example that serves as an image by holding a recordation medium 104 on a surface of a drum 110 serving as a recordation medium holding device. A light source unit described in one of the above-mentioned first to third embodiments is used and forms an image by emitting a light beam to the recordation medium.

FIG. 10C illustrates an exemplary image forming apparatus for forming an image on a recordation medium secured to a drum 501 by emitting lights to the surface thereof from a light source unit that includes a plurality of light sources. The image forming apparatus of FIG. 10C includes a x-stage 502 that moves a light source unit 500 in the sub scanning direction step by step by not more than one pixel pitch as a writing device, and a z-stage 502 that adjusts a position of the light source unit 500 in a focal point direction so as to form a two dimensional image on a surface of a drum 501. The image forming apparatus of FIG. 10C also includes a function to drive the x-stage 502 and controls transmission of information of an image to the light source unit 500 in synchronism with rotation of the drum 501. The present invention, however, is not limited to such a drum scanning type image forming apparatus, and includes various systems in which a plurality of dispersed light sources are employed and form an image.

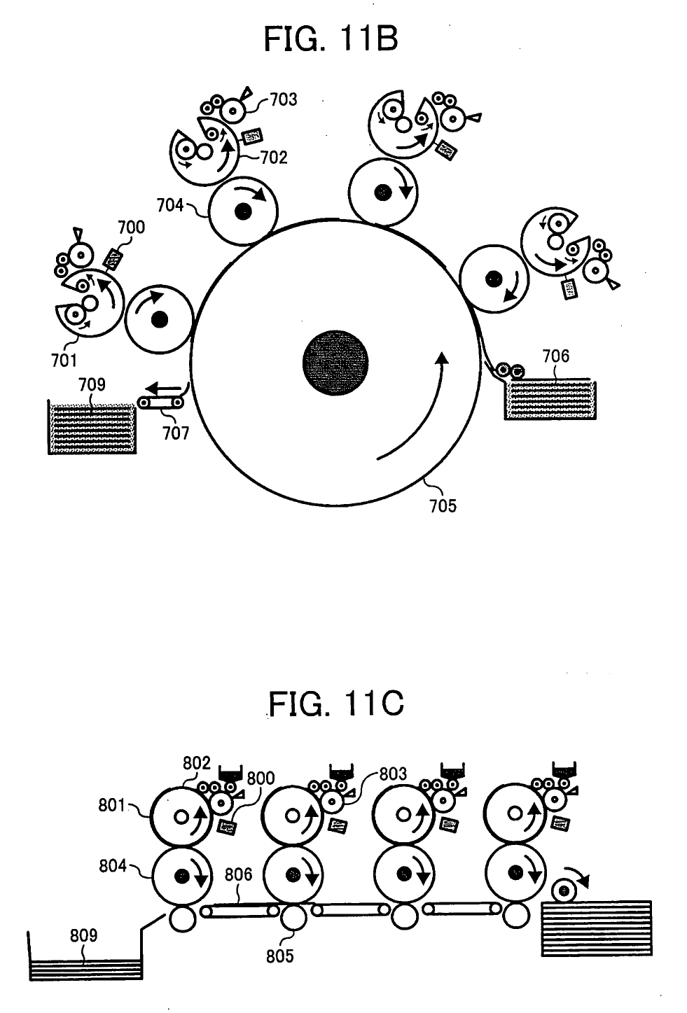

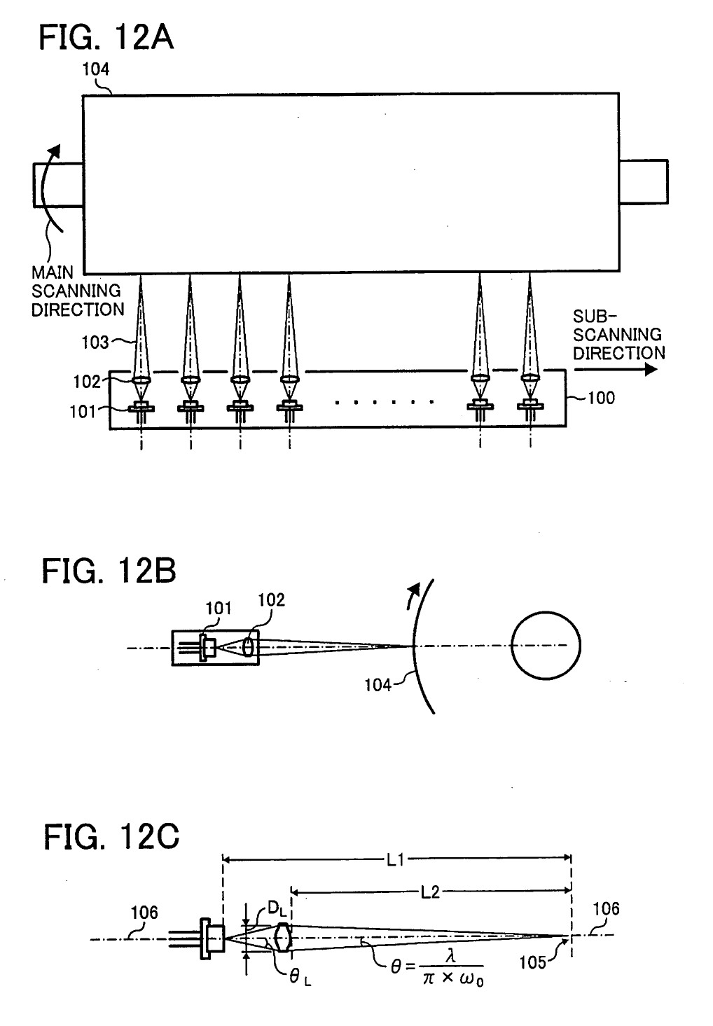

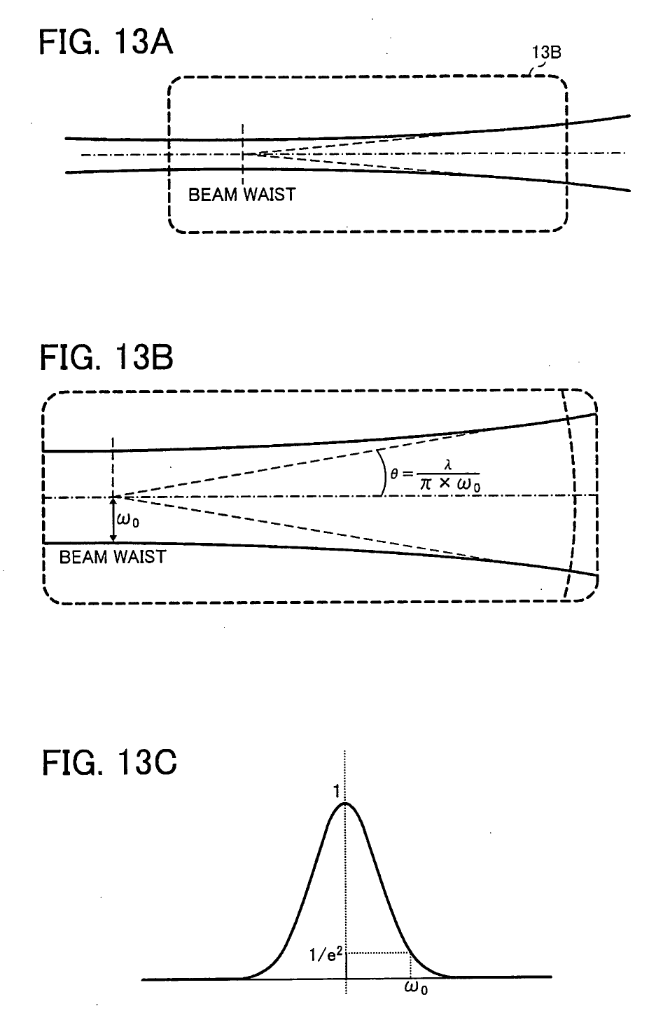

The fifth embodiment is now described with reference to FIGS. 1A to 1C, wherein an exemplary printing system mounts an image forming apparatus similar to that described in the fourth embodiment. Specifically, FIG. 11A illustrates an exemplary mono-color printing system, such as a DI (Direct Imaging) machine including the image forming apparatus. FIG. 11B illustrates an exemplary multicolor printing system, such as a DI machine, which includes an impression cylinder beside an image forming apparatus. FIG. 11C illustrates an exemplary multicolor printing system of a four tandem DI machine each including an impression cylinder beside the image forming apparatus.

The DI machine includes dual functions of producing a machine plate by exposing a printing plate in accordance with image information transmitted from a computer and executing printing on a printing sheet.

The light source unit 600 exposes a recordation medium 601 such as a printing plate, etc., in accordance with the image information and forms both ink adhesion and repellent regions on the surface of the recordation medium 601. When the recordation medium 601 is set to the drum 602, all of the drum 602, an intermediate transfer member 604, an inking roller group 603, and a pressure roller 605 are rotated in synchronism with each other. Then, ink is supplied to the ink adhering region from the inking roller 603, thereby an ink image is formed. The ink image is transferred onto the intermediate transfer member 604 made of rubber, such as a bracket, etc., and is further transferred onto a printing sheet 606. Then, the printing sheet 606 is conveyed by a printing material conveyance device 607, thereby a printing material 609 is obtained. A used recordation medium 601 is installed in a container 608.

The printing system of FIG. 11B includes four units for four colors (CMYK) around a pressure drum 705, wherein each of the four units mainly includes an inking roller group 703, a recordation medium holding drum 702, a light source unit 700, and an intermediate transfer member 704. An operation of each of the units for four colors is substantially the same to that performed in FIG. 11A. However, a light source unit 700 exposes the recordation medium 701 in this example, when a recordation medium 701 is set to a drum 702. During printing, respective structural elements of the units and the pressure drum 705 rotate in synchronism with each other, and a color image is transferred one after another, thereby a full color image is printed on a printing sheet 706.

The printing system of FIG. 11C includes a plurality of tandem units for respective colors. Each of the units mainly includes an inking roller group 803 for each color, a recordation medium (e.g. a printing plate), a recordation medium holding drum 802, a light source unit 800, an intermediate transfer member (e.g. a bracket) 804, and a pressure drum 805. A printing operation is executed in substantially the same manner as executed in the printing system of FIG. 11B. Even though an arrangement angle of each of units for respective colors is different between these examples of FIGS. 11B and 11C, an entry angle of a light beam toward the imaging surface is set to meet the above-mentioned second and fourth formulas in each of the light source units of FIGS. 11A to 11C.

Obviously, numerous additional modifications and variations of the present invention are possible in light of the above teachings. It is therefore to be understood that within the scope of the appended claims, the present invention may be practiced otherwise than as specifically described herein.

What is claimed is:

1. An optical light source unit, comprising:
a light source configured to emit a beam; and
a collimate lens configured to collimate the beam and execute imaging on an imaging surface;
wherein said beam substantially has light intensity of Gauss distribution in a cross section after passing through the collimate lens;
wherein a radius ω₂ of said beam in a cross section is larger in a sub scanning direction than that ω₁ in a main scanning direction at a beam waist;
wherein a radius ω4 of said beam is larger in a sub scanning direction than that ω3 in a main scanning direction on the imaging surface;
wherein said radius ω₃ is defined by the following formula when θₘₐᵢₙ is an angle of the beam entering the imaging surface in the main scanning direction with a normal line of the imaging surface;
ω₃=ω₁/cos θₘₐᵢₙ;
and wherein an angle θₘₐₓ of said beam entering the imaging surface with a normal line of the imaging surface is larger than a diverse angle θ₀ of the beam returning and diverging from the imaging surface, wherein said diverse angle θ₀ is defined by the following formula, wherein λ is a wave length of the light source, π is a circular ratio, and ω₀ is a radius of the beam in a cross section at the beam waist in a beam entry direction;
θ₀=λ/(π×ω₀).

2. The optical light source unit as claimed in claim 1, wherein said θₘₐₓ is the same to an angle θₘₐᵢₙ, and said ω₀ is the same to ω₁, when said entry beam is only angled in the main scanning direction.

3. The optical light source unit as claimed in claim 1, further comprising a light deviation device configured to change a direction and guides the beam to the imaging surface through the collimate lens.

4. The optical light source unit as claimed in claim 3, wherein said light deviation device includes one of a mirror and a prism.

5. An optical light source unit, comprising:
a first light source train including at least two light sources and configured to emit light beams from above an imaging position; and
a second light source train including at least two light sources and configured to emit light beams from beneath the imaging position;
wherein the at least two light sources of the fist and second light source trains are staggered at a prescribed interval D₁ so that a light beam emitted from one of the at least two light sources of the first light source train does not enter the one of the at least two light sources of the second light source train after returning from the imaging surface.

6. The optical light source unit as claimed in claim 5, wherein when said light source emits the light beam toward the imaging surface in the main scanning direction while a divergent angle θ₀ of the return light beam is defined by the following formula, the prescribed interval D₁ is calculated by the following formula, wherein λ is a wave length of the light source, π is a circular ratio, ω₂ is a radius of the light beam at a beam waist in the sub scanning direction, and L₁ is a distance from the light source to the imaging surface;
θ₀=λ/(π×ω₂);
D₁≧L₁×tan θ₀.

7. An optical light source unit, comprising:
a first light source train including at least two pair of light sources and focal lenses and configured to emit light beams from above an imaging position; and
a second light source train including at least two pair of light sources and focal lenses and configured to emit light beams from beneath the imaging position;
wherein, the at least two focal lens of the first and second light source trains are mutually staggered at a prescribed interval so that a light beam emitted through one of the at least two light sources of the first light source train and returning from the imaging surface does not enter one of the at least two focal lens of the second light source train.

8. The optical light source unit as claimed in claim 7, wherein when said beam enters the imaging surface in the main scanning direction through one of the plurality of focal lens while a divergent angle θ₂ of the return light is defined by the following formula, the prescribed interval D₂ is calculated by the following formula, wherein λ is a wave length of a light source, π is a circular ratio, ω₂ is a radius of the beam in the sub scanning direction at a beam waist, and L₂ is a distance between the focal lens and the imaging surface;
θ₂=λ/(π×ω₂);
D₂≧L₂×tan θ₂.

9. An image forming apparatus employing a light source unit as claimed in claim 1, wherein an image is formed on a recording medium by a light beam emitted from the light source unit.

10. The image forming apparatus as claimed in claim 9, further comprising:
a recording medium holding device configured to hold and rotate the recordation medium; and
a light source unit-moving device configured to relatively move the light source unit perpendicular to a rotational direction of the recordation medium in synchronism with the rotation of the recording medium holding device.

11. The image forming apparatus as claimed in claim 9, further comprising:
a color material-supplying device configured to adhere color material to an image region on the recordation medium;
a conveyance device configured to convey a transfer sheet; and
a transfer device configured to transfer the color material adhered to the image region onto the transfer sheet.
